(19) United States
(12) Patent Application Publication
(10) Pub. No.: US 2026/0270672 A1
(43) Pub. Date: Sep. 10, 2026

(54) MULTI-BLUETOOTH-CHIP CONTROL SYSTEM AND SMART DEVICE

(71) Applicant: SHENZHEN FEASYCOM CO., LTD., Shenzhen City (CN)

(72) Inventors: TAN WANG, Shenzhen City (CN); YONGQING SHAO, Shenzhen City (CN)

(73) Assignee: SHENZHEN FEASYCOM CO., LTD., Shenzhen City (CN)

(21) Appl. No.: 19/661,612

(22) Filed: Apr. 28, 2026

Related U.S. Application Data
(63) Continuation of application No. PCT/CN2025/078323, filed on Feb. 20, 2025.

(30) Foreign Application Priority Data
Feb. 26, 2024 (CN) 202410207076.5

(51) Int. Cl. H04W 4/80; H04L 69/22; H04W 80/08

(52) U.S. Cl. CPC H04W 4/80; H04L 69/22; H04W 80/08

(57) ABSTRACT

The present invention relates to a multi-Bluetooth-chip control system and a smart device. In the system, a multi-Bluetooth driver module receives a Bluetooth data packet sent by a Bluetooth chip, adds preset identification to it, and transmits it to a Bluetooth protocol stack upper-layer module, where the preset identification corresponds one-to-one with the Bluetooth chip. The Bluetooth protocol stack upper-layer module parses the preset identification of the Bluetooth data packet and determines the Bluetooth chip to which each Bluetooth data packet belongs. The Bluetooth protocol stack upper-layer module sends a Bluetooth data packet containing the preset identification to the multi-Bluetooth driver module, which parses the preset identification and sends the Bluetooth data packet to the corresponding Bluetooth chip. By marking and identifying Bluetooth data packet, the present invention enables a single Bluetooth driver module to simultaneously drive multiple Bluetooth chips, thereby reducing software and hardware overhead and lowering costs.

### CROSS REFERENCE TO RELATED APPLICATION

This application is a continuation of International Patent Application No. PCT/CN2025/078323, filed on Feb. 20, 2025, which claims priority of China Patent Application No. 202410207076.5 filed on Feb. 26, 2024. The contents of the above-identified applications are incorporated herein by reference.

### TECHNICAL FIELD

The present invention relates to the field of Bluetooth devices, and more specifically, to a multi-Bluetooth-chip control system and a smart device.

### DESCRIPTION OF RELATED ART

Bluetooth communication technology, as a short-range communication method, facilitates wireless communication connections between devices within a small area. In scenarios where a single smart device needs to connect to multiple Bluetooth peripherals simultaneously, existing technologies require multiple sets of Bluetooth protocol stacks and Bluetooth chip combinations because a single Bluetooth protocol stack can only control one Bluetooth chip. However, this approach not only occupies significant space during hardware board layout and increases wiring complexity but also demands substantial software resources and incurs higher costs.

### BRIEF SUMMARY OF THE INVENTION

The technical problem to be solved by the present invention is to provide a multi-Bluetooth-chip control system and a smart device.

The technical solution adopted by the present invention to solve the technical problem is to construct a multi-Bluetooth-chip control system, comprising a Bluetooth protocol stack upper-layer module, a multi-Bluetooth driver module, and at least two Bluetooth chips. The Bluetooth protocol stack upper-layer module is respectively connected to each Bluetooth chip through the multi-Bluetooth driver module.

The multi-Bluetooth driver module receives Bluetooth data packet sent by Bluetooth chip, adds a preset identification to the Bluetooth data packet, and then transmits the Bluetooth data packet to the Bluetooth protocol stack upper-layer module. The preset identification corresponds one-to-one with the Bluetooth chip. The Bluetooth protocol stack upper-layer module parses the preset identification of the Bluetooth data packet and determines the Bluetooth chip to which the Bluetooth data packet belongs based on the preset identification.

The Bluetooth protocol stack upper-layer module sends Bluetooth data packet containing the preset identification to the multi-Bluetooth driver module. The multi-Bluetooth driver module parses the preset identification of the Bluetooth data packet and sends the Bluetooth data packet to the Bluetooth chip corresponding to the preset identification.

Further, in the multi-Bluetooth-chip control system of the present invention, the multi-Bluetooth driver module sets a preset field of the Bluetooth data packet as the preset identification, and the Bluetooth protocol stack upper-layer module parses the preset identification of the Bluetooth data packet from the preset field.

The Bluetooth protocol stack upper-layer module sets the preset field of the Bluetooth data packet as the preset identification, and the multi-Bluetooth driver module parses the preset identification of the Bluetooth data packet from the preset field.

Further, in the multi-Bluetooth-chip control system of the present invention, after parsing the preset identification of the Bluetooth data packet from the preset field, the Bluetooth protocol stack upper-layer module restores the preset field to preset data.

After parsing the preset identification of the Bluetooth data packet from the preset field, the multi-Bluetooth driver module restores the preset field to preset data.

Further, in the multi-Bluetooth-chip control system of the present invention, before parsing the Bluetooth data packet, the Bluetooth protocol stack upper-layer module and the multi-Bluetooth driver module identify the data type to which the Bluetooth data packet belongs, determine the position of the preset field based on the data type, where the data type and the preset field correspond one-to-one.

Further, in the multi-Bluetooth-chip control system of the present invention, the preset field is the 8th and 9th bytes of the header of the Bluetooth data packet; or the preset field is the 14th and 15th bytes of the header of the Bluetooth data packet.

Further, in the multi-Bluetooth-chip control system of the present invention, the preset field is located in the header of the Bluetooth data packet.

Further, in the multi-Bluetooth-chip control system of the present invention, the Bluetooth protocol stack upper-layer module and the multi-Bluetooth driver module store a corresponding relationship between the preset identifications and the Bluetooth chips.

Further, in the multi-Bluetooth-chip control system of the present invention, the multi-Bluetooth driver module comprises at least two serial interfaces, each of which is connected to one of the Bluetooth chips.

Additionally, the present invention also provides a smart device, comprising the aforementioned multi-Bluetooth-chip control system.

Further, in the smart device of the present invention, the smart device is connected to at least two Bluetooth peripherals, each of which is simultaneously connected to the smart device.

The implementation of the multi-Bluetooth-chip control system and the smart device of the present invention has the following beneficial effects: By marking and identifying Bluetooth data packets, the present invention enables a single Bluetooth driver module to simultaneously drive multiple Bluetooth chips, thereby reducing software and hardware overhead and cutting costs.

### BRIEF DESCRIPTION OF THE SEVERAL VIEWS OF THE DRAWINGS

The present invention will be further described below in conjunction with the accompanying drawings and embodiments. In the drawings:

FIG. 1 is a schematic structural diagram of a multi-Bluetooth-chip control system according to an embodiment of the present invention;

FIG. 2 is a schematic structural diagram of a smart device according to an embodiment of the present invention.

### DETAILED DESCRIPTION OF THE INVENTION

To provide a clearer understanding of the technical features, objectives, and effects of the present invention, the specific embodiments of the invention are described in detail below with reference to the accompanying drawings.

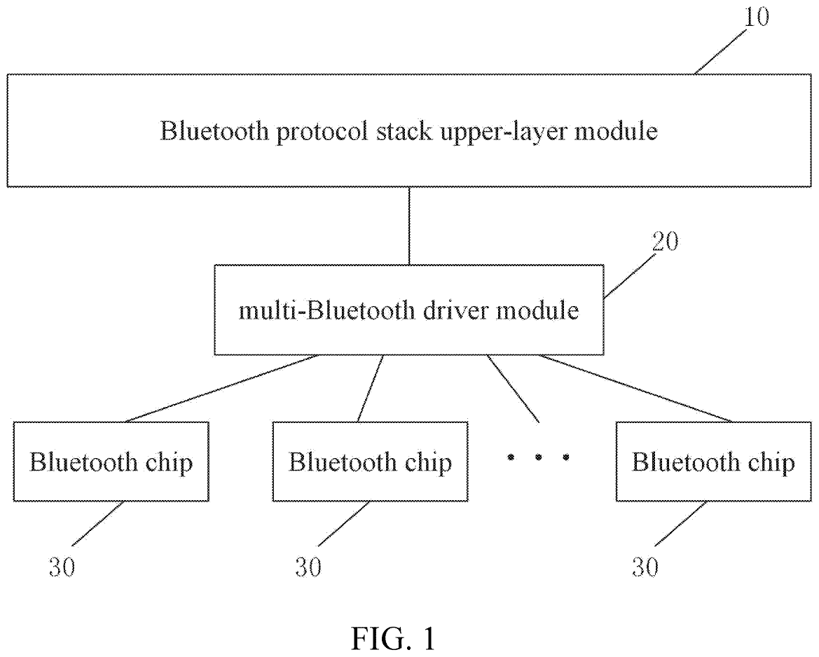

In a preferred embodiment, referring to FIG. 1, this embodiment provides a multi-Bluetooth-chip control system, which can achieve simultaneous connections with multiple Bluetooth peripherals based on a multi-Bluetooth driver module 20. The multi-Bluetooth-chip control system includes a Bluetooth protocol stack upper-layer module 10, a multi-Bluetooth driver module 20, and at least two Bluetooth chips 30. The Bluetooth protocol stack upper-layer module 10 is connected to each Bluetooth chip 30 via the multi-Bluetooth driver module 20. The Bluetooth protocol stack upper-layer module 10 is configured to process Bluetooth data packets and provide the processed data for use by upper-layer applications, as well as receive data from the upper-layer applications, process the data, and transmit it to the multi-Bluetooth driver module 20. The multi-Bluetooth driver module 20 is configured to drive multiple Bluetooth chips 30, enabling communication between the Bluetooth protocol stack upper-layer module 10 and each Bluetooth chip 30. Each Bluetooth chip 30 is configured to connect to one Bluetooth peripheral and supports simultaneous connections with multiple Bluetooth peripherals.

Specifically, the operation of the multi-Bluetooth-chip control system is divided into a Bluetooth data transmission process and a Bluetooth data reception process, which are described separately below.

Bluetooth data transmission process: The upper-layer application sends the data to be transmitted to the Bluetooth protocol stack upper-layer module 10. The Bluetooth protocol stack upper-layer module 10 encapsulates the data into a Bluetooth data packet based on the Bluetooth chip 30 to which the data belongs and adds a preset identification to the Bluetooth data packet. The preset identification is used to identify the Bluetooth chip 30, with each preset identification corresponding to one Bluetooth chip 30. Further, the Bluetooth protocol stack upper-layer module 10 sends the Bluetooth data packet containing the preset identification to the multi-Bluetooth driver module 20. The multi-Bluetooth driver module 20 parses the preset identification from the Bluetooth data packet and transmits the Bluetooth data packet to the Bluetooth chip 30 corresponding to the preset identification. Upon receiving the Bluetooth data packet, the Bluetooth chip 30 converts it into a Bluetooth signal and transmits it to an external Bluetooth peripheral.

Bluetooth data reception process: The Bluetooth chip 30 receives a Bluetooth data packet sent by a Bluetooth peripheral and transmits it to the multi-Bluetooth driver module 20. Upon receiving the Bluetooth data packet from the Bluetooth chip 30, the multi-Bluetooth driver module 20 adds a preset identification to the Bluetooth data packet. Understandably, since the connection relationship between the multi-Bluetooth driver module 20 and the multiple Bluetooth chips 30 is already fixed, the multi-Bluetooth driver module 20 can identify which Bluetooth chip 30 the Bluetooth data packet originates from upon reception and accordingly assign the corresponding preset identification. Subsequently, the multi-Bluetooth driver module 20 transmits the Bluetooth data packet with preset identification to the Bluetooth protocol stack upper-layer module 10. The Bluetooth protocol stack upper-layer module 10 parses the preset identification from the Bluetooth data packet, determines the originating Bluetooth chip 30 based on the preset identification, and forwards the parsed data to the upper-layer application.

This embodiment achieves simultaneous control of multiple Bluetooth chips by a single driver module through tagging and identifying Bluetooth data packets. Compared to existing solutions where each Bluetooth chip requires a dedicated driver module, this approach reduces both software and hardware overhead, thereby lowering costs.

In some multi-Bluetooth-chip control system embodiments, building upon the above implementation, to enable the Bluetooth protocol stack upper-layer module 10 and the multi-Bluetooth driver module 20 to recognize the Bluetooth data packets sent by each other, the Bluetooth protocol stack upper-layer module 10 and the multi-Bluetooth driver module 20 need to be preconfigured with two parameters: a first parameter and a second parameter. The first parameter defines the correspondence relationship between preset identifications and Bluetooth chips 30, while the second parameter specifies the preset field for the preset identification. These are elaborated below.

The first parameter is the correspondence relationship, which refers to the relationship between preset identifications and Bluetooth chips 30. The Bluetooth protocol stack upper-layer module 10 stores the correspondence relationship between preset identifications and Bluetooth chips 30, while the multi-Bluetooth driver module 20 also stores the correspondence relationship between preset identifications and Bluetooth chips 30. Moreover, the Bluetooth protocol stack upper-layer module 10 and the multi-Bluetooth driver module 20 store the same correspondence relationship between preset identifications and the Bluetooth chips 30. It should be understood that once the connection relationship between the multi-Bluetooth driver module 20 and at least two Bluetooth chips 30 in this multi-Bluetooth-chip control system is fixed, each Bluetooth chip 30 can be assigned a number, a preset identification can be set for each Bluetooth chip 30, and the correspondence relationship between preset identifications and Bluetooth chips 30 can be stored in both the Bluetooth protocol stack upper-layer module 10 and the multi-Bluetooth driver module 20.

The second parameter is the preset field of the preset identification. It is necessary to predefine the position of the preset identification in the Bluetooth data packet, i.e., the preset field used to store the preset identification in the Bluetooth data packet. This ensures that the Bluetooth protocol stack upper-layer module 10 and the multi-Bluetooth driver module 20 can add and read the preset identification at the same position.

For example, during Bluetooth data transmission process, the Bluetooth protocol stack upper-layer module 10 sets the preset field of the Bluetooth data packet to the preset identification, and the multi-Bluetooth driver module 20 parses the preset identification from the preset field of the Bluetooth data packet.

For example, during Bluetooth data reception process, the multi-Bluetooth driver module 20 sets the preset field of the Bluetooth data packet to the preset identification, and the Bluetooth protocol stack upper-layer module 10 parses the preset identification from the preset field of the Bluetooth data packet.

In this embodiment, by configuring the first and second parameters, the position of the preset identification in the Bluetooth data packet is fixed. This enables the Bluetooth protocol stack upper-layer module and the multi-Bluetooth driver module to recognize each other's transmitted Bluetooth data packets, thereby allowing a single multi-Bluetooth driver module to simultaneously drive multiple Bluetooth chips.

In some embodiments of a multi-Bluetooth-chip control system, to avoid affecting the use of Bluetooth data packet by adding preset identification, this embodiment resets the preset fields of the Bluetooth data packets after identification, restoring them to their state before the preset identification was added. The details are explained below.

During Bluetooth data transmission process, the multi-Bluetooth driver module 20 restores the preset field to preset data after parsing the preset identification from the Bluetooth data packet. At this point, the preset field of the Bluetooth data packet sent to the corresponding Bluetooth chip 30 has been restored to the preset data, meaning the Bluetooth data packet is identical to those in prior art. This ensures compatibility with existing Bluetooth chips 30 for reading and processing, eliminating the need for modifications and reducing development and usage costs.

During Bluetooth data reception process, the Bluetooth protocol stack upper-layer module 10 restores the preset field to preset data after parsing the preset identification from the Bluetooth data packet. At this point, the preset field of the Bluetooth data packet sent to the upper-layer application has been restored to the preset data, meaning the Bluetooth data packet is identical to those in prior art. This ensures compatibility with existing upper-layer applications for reading and processing, eliminating the need for modifications and reducing development and usage costs.

In this embodiment, after completing Bluetooth chip identification for the Bluetooth data packet, the Bluetooth data packet is restored to a standard Bluetooth data packet consistent with prior art. This ensures no impact on existing Bluetooth functional modules, reducing development and usage costs.

In some embodiments of the multi-Bluetooth-chip control system, building upon the aforementioned embodiments, considering that different Bluetooth specifications use different data types, such as HCI Command Packet, HCI Event Packet, HCI ACL Data Packet, etc., and th at the preset fields available for storing preset identifications vary for each data type, this embodiment requires determining the preset field based on the data type of the Bluetooth packet.

Specifically, according to the parameter standards of Bluetooth data packets for each data type, the positions within the Bluetooth data packets of each data type used to store preset identification are pre-determined. A correspondence relationship between data types and preset fields is established, where each data type corresponds to one preset field in a one-to-one manner. This correspondence relationship is then stored in both the Bluetooth protocol stack upper-layer module 10 and the multi-Bluetooth driver module 20.

During the Bluetooth data transmission process, after the multi-Bluetooth driver module 20 receives a Bluetooth data packet sent by the Bluetooth protocol stack upper-layer module 10, it first identifies the data type of the Bluetooth data packet. It then determines the preset field based on the correspondence relationship between data types and preset fields, and extracts the preset identification from the preset field of the Bluetooth data packet. Subsequently, the Bluetooth chip 30 is determined according to the correspondence relationship between the preset identifications and the Bluetooth chips 30, and the Bluetooth data packet is transmitted to the Bluetooth chip 30 for emission.

During the Bluetooth data reception process, after the Bluetooth protocol stack upper-layer module 10 receives a Bluetooth data packet, it first identifies the data type corresponding to the Bluetooth data packet. Then, based on the correspondence relationship between the data types and preset fields, the preset field is determined, and a preset identification is parsed from the preset field of the Bluetooth data packet. Subsequently, the Bluetooth chip 30 to which the Bluetooth data packet belongs is determined according to the correspondence relationship between the preset identification and the Bluetooth chip 30.

Optionally, the preset field may be located in the header of the Bluetooth data packet.

For example, the preset field may be the 8th and 9th bytes of the Bluetooth data packet header.

For another example, the preset field may be the 14th and 15th bytes of the Bluetooth data packet header.

The above two embodiments involve two bytes, allowing the configuration of four Bluetooth chips 30. For instance, the preset identifications corresponding to the four Bluetooth chips 30 can be set to 00, 01, 10, and 11, respectively. Taking the preset field as the 8th and 9th bytes of the Bluetooth data packet header as an example, the four Bluetooth chips 30 in this embodiment are Bluetooth Chip 1, Bluetooth Chip 2, Bluetooth Chip 3, and Bluetooth Chip 4, wherein, the preset identification of Bluetooth chip 1 is 00, the preset identification of Bluetooth chip 2 is 01, the preset identification of Bluetooth chip 3 is 10, and the preset identification of Bluetooth chip 4 is 11. Specifically, the Bluetooth data transmission process and the Bluetooth data reception process are described below.

### Bluetooth Data Transmission Process

The upper-layer application delivers the data to be sent to the Bluetooth protocol stack upper-layer module 10. The Bluetooth protocol stack upper-layer module 10 encapsulates the data into a Bluetooth data packet based on the Bluetooth chip 30 to which the data belongs and adds the preset identification to the 8th and 9th bytes of the Bluetooth data packet header.

If the Bluetooth data packet is to be sent to Bluetooth Chip 1, set the 8th and 9th bytes of the Bluetooth data packet header to 00;

If the Bluetooth data packet is to be sent to Bluetooth Chip 2, set the 8th and 9th bytes of the Bluetooth data packet header to 01;

If the Bluetooth data packet is to be sent to Bluetooth Chip 3, set the 8th and 9th bytes of the Bluetooth data packet header to 10;

If the Bluetooth data packet is to be sent to Bluetooth Chip 4, set the 8th and 9th bytes of the Bluetooth data packet header to 11.

Furthermore, the Bluetooth protocol stack upper-layer module 10 delivers a Bluetooth data packet containing a preset identification to the multi-Bluetooth driver module 20. The multi-Bluetooth driver module 20 parses the preset identification of the Bluetooth data packet, i.e., the 8th and 9th bytes of the Bluetooth data header, which may be one of 00, 01, 10, or 11.

If the parsed preset identification is 00, the Bluetooth data packet is sent to Bluetooth Chip 1;

If the parsed preset identification is 01, the Bluetooth data packet is sent to Bluetooth Chip 2;

If the parsed preset identification is 10, the Bluetooth data packet is sent to Bluetooth Chip 3;

If the parsed preset identification is 11, the Bluetooth data packet is sent to Bluetooth Chip 4.

After receiving the Bluetooth data packet, Bluetooth Chip 30 converts the Bluetooth data packet into a Bluetooth signal and transmits it to an external Bluetooth peripheral device.

### Bluetooth Data Reception Process

The Bluetooth chip 30 receives a Bluetooth data packet sent by a Bluetooth peripheral and transmits the Bluetooth data packet to the multi-Bluetooth driver module 20. After receiving the Bluetooth data packet from the Bluetooth chip 30, the multi-Bluetooth driver module 20 adds a preset identification to the Bluetooth data packet.

If the Bluetooth data packet originates from Bluetooth chip 1, the 8th and 9th bytes of the Bluetooth data packet header are set to 00.

If the Bluetooth data packet originates from Bluetooth chip 2, the 8th and 9th bytes of the Bluetooth data packet header are set to 01.

If the Bluetooth data packet originates from Bluetooth chip 3, the 8th and 9th bytes of the Bluetooth data packet header are set to 10.

If the Bluetooth data packet originates from Bluetooth chip 4, the 8th and 9th bytes of the Bluetooth data packet header are set to 11.

Subsequently, the multi-Bluetooth driver module 20 transmits the Bluetooth data packet with the preset identification to the Bluetooth protocol stack upper-layer module 10. The Bluetooth protocol stack upper-layer module 10 parses the preset identification of the Bluetooth data packet, specifically the 8th and 9th bytes of the Bluetooth data packet header, which may be one of 00, 01, 10, or 11.

If the parsed preset identification is 00, it indicates that the Bluetooth data packet originates from Bluetooth chip 1.

If the parsed preset identification is 01, it indicates that the Bluetooth data packet originates from Bluetooth chip 2.

If the parsed preset identification is 10, it indicates that the Bluetooth data packet originates from Bluetooth chip 3.

If the parsed preset identification is 11, it indicates that the Bluetooth data packet originates from Bluetooth chip 4.

The Bluetooth stack upper-layer module 10 determines the Bluetooth chip 30 to which the Bluetooth data packet belongs based on a preset identification, and transmits the parsed data to the upper-layer application.

It should be understood that the above embodiments are merely illustrative of the preset identification in Bluetooth data packets and are not uniquely limiting. Selecting other positions as preset identification based on the inventive concept of this embodiment also falls within the scope of this embodiment.

This embodiment pre-stores preset fields corresponding to Bluetooth data packets of different data types, thereby enabling the identification of various Bluetooth data packets and improving system versatility.

In some embodiments of the multi-Bluetooth-chip control system, the multi-Bluetooth driver module 20 includes at least two serial interfaces, such as UART interfaces, with each serial interface connected to one Bluetooth chip 30. It should be understood that in actual products, once multiple Bluetooth chips 30 are connected to the same multi-Bluetooth driver module 20, the correspondence relationship between the Bluetooth chips 30 and the serial interfaces is determined. The multi-Bluetooth driver module 20 can identify the corresponding Bluetooth chip 30 based on which serial interface the Bluetooth data packet originates from.

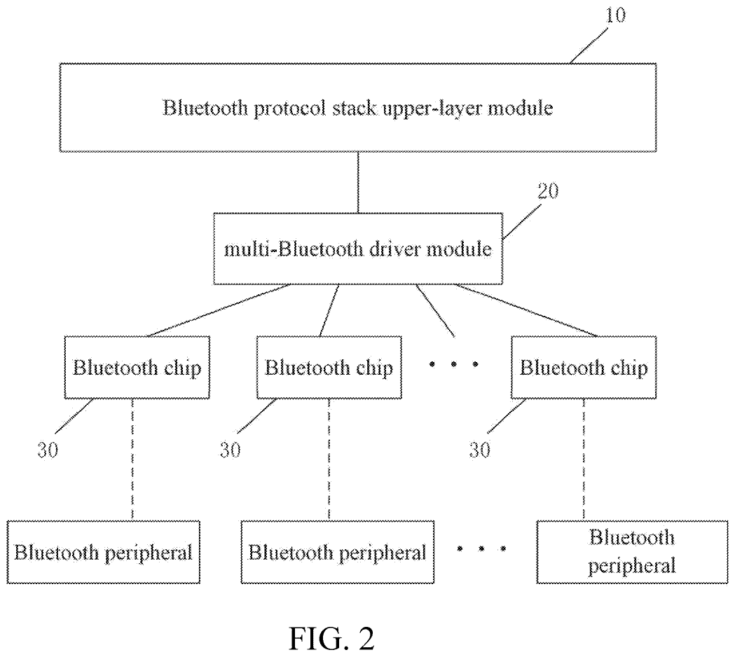

In a preferred embodiment, referring to FIG. 2, this embodiment provides a smart device, and the smart device includes the multi-Bluetooth-chip control system described in the above embodiments. Optionally, the smart device includes, but is not limited to, smart vehicle-mounted devices, smart furniture, smart mobile devices, etc.

In some embodiments of the smart device, the smart device connects to at least two Bluetooth peripherals, with each Bluetooth peripheral simultaneously connected to the smart device. The Bluetooth peripheral refers to an external device with Bluetooth functionality. Optionally, Bluetooth peripherals include, but are not limited to, Bluetooth headsets, Bluetooth display modules, Bluetooth sensors, Bluetooth handheld terminals, etc.

The various embodiments in this specification are described in a progressive manner, with each embodiment focusing on differences from other embodiments. Similar or identical parts between embodiments can be cross-referenced. For the devices disclosed in the embodiments, since they correspond to the methods disclosed in the embodiments, the descriptions are relatively brief, and relevant details can be found in the method section.

Professionals may further recognize that the units and algorithm steps of the examples described in the disclosed embodiments can be implemented in electronic hardware, computer software, or a combination of both. To clearly illustrate the interchangeability of hardware and software, the composition and steps of each example have been generally described in terms of functionality in the above description. Whether these functions are performed by hardware or software depends on the specific application and design constraints of the technical solution. Professionals may use different methods for each specific application to implement the described functionality, but such implementations should not be considered beyond the scope of the present invention.

The steps of the methods or algorithms described in connection with the embodiments disclosed herein may be implemented directly in hardware, in software modules executed by a processor, or in a combination of both. Software modules may reside in random access memory (RAM), internal memory, read-only memory (ROM), electrically programmable ROM, electrically erasable programmable ROM, registers, hard disks, removable disks, CD-ROMs, or any other form of storage medium known in the technical field.

The above embodiments are merely intended to illustrate the technical concepts and features of the present invention, aiming to enable those skilled in the art to understand the content of the invention and implement it accordingly. They are not intended to limit the scope of protection of the present invention. Any equivalent modifications or variations made within the scope of the claims of the present invention shall fall within the coverage of the claims of the present invention.

What is claimed is:

1. A multi-Bluetooth-chip control system, wherein the system comprising a Bluetooth protocol stack upper-layer module, a multi-Bluetooth driver module, and at least two Bluetooth chips, the Bluetooth protocol stack upper-layer module is connected to each of the Bluetooth chips through the multi-Bluetooth driver module;
the multi-Bluetooth driver module receives Bluetooth data packet sent by Bluetooth chip, adds preset identification to the Bluetooth data packet, and then transmits the Bluetooth data packet to the Bluetooth protocol stack upper-layer module, the preset identification correspond one-to-one with the Bluetooth chip; the Bluetooth protocol stack upper-layer module parses the preset identification of the Bluetooth data packet and determines the Bluetooth chip to which the Bluetooth data packet belongs based on the preset identification;
the Bluetooth protocol stack upper-layer module sends Bluetooth data packet containing the preset identification to the multi-Bluetooth driver module, the multi-Bluetooth driver module parses the preset identification of the Bluetooth data packet and sends the Bluetooth data packet to the Bluetooth chip corresponding to the preset identification.

2. The multi-Bluetooth-chip control system according to claim 1, wherein the multi-Bluetooth driver module sets a preset field of the Bluetooth data packet as the preset identification, and the Bluetooth protocol stack upper-layer module parses the preset identification of the Bluetooth data packet from the preset field;
the Bluetooth protocol stack upper-layer module sets the preset field of the Bluetooth data packet as the preset identification, and the multi-Bluetooth driver module parses the preset identification of the Bluetooth data packet from the preset field.

3. The multi-Bluetooth-chip control system according to claim 2, wherein the Bluetooth protocol stack upper-layer module restores the preset field to preset data after parsing the preset identification of the Bluetooth data packet from the preset field;
the multi-Bluetooth driver module restores the preset field to preset data after parsing the preset identification of the Bluetooth data packet from the preset field.

4. The multi-Bluetooth-chip control system according to claim 2, wherein the Bluetooth protocol stack upper-layer module and the multi-Bluetooth driver module identify the data type to which the Bluetooth data packet belongs before parsing the Bluetooth data packet, and determine the position of the preset field based on the data type, where the data type and the preset field correspond one-to-one.

5. The multi-Bluetooth-chip control system according to claim wherein the preset field is the 8th and 9th bytes of the header of the Bluetooth data packet; or
the preset field is the 14th and 15th bytes of the header of the Bluetooth data packet.

6. The multi-Bluetooth-chip control system according to claim 2, wherein the preset field is located in the header of the Bluetooth data packet.

7. The multi-Bluetooth-chip control system according to claim 1, wherein the Bluetooth protocol stack upper-layer module and the multi-Bluetooth driver module store the correspondence relationship between the preset identifications and the Bluetooth chips.

8. The multi-Bluetooth-chip control system according to claim 1, wherein the multi-Bluetooth driver module comprises at least two serial interfaces, each of which is connected to one of the Bluetooth chips.

9. A smart device, wherein the smart device comprises the multi-Bluetooth-chip control system, the system comprising a Bluetooth protocol stack upper-layer module, a multi-Bluetooth driver module, and at least two Bluetooth chips, the Bluetooth protocol stack upper-layer module is connected to each of the Bluetooth chips through the multi-Bluetooth driver module;
the multi-Bluetooth driver module receives Bluetooth data packet sent by Bluetooth chip, adds preset identification to the Bluetooth data packet, and then transmits the Bluetooth data packet to the Bluetooth protocol stack upper-layer module, the preset identification correspond one-to-one with the Bluetooth chip; the Bluetooth protocol stack upper-layer module parses the preset identification of the Bluetooth data packet and determines the Bluetooth chip to which the Bluetooth data packet belongs based on the preset identification;
the Bluetooth protocol stack upper-layer module sends Bluetooth data packet containing the preset identification to the multi-Bluetooth driver module, the multi-Bluetooth driver module parses the preset identification of the Bluetooth data packet and sends the Bluetooth data packet to the Bluetooth chip corresponding to the preset identification.

10. The smart device according to claim 9, wherein the smart device is connected to at least two Bluetooth peripherals, each of which is simultaneously connected to the smart device.

11. The smart device according to claim 9, wherein the multi-Bluetooth driver module sets a preset field of the Bluetooth data packet as the preset identification, and the Bluetooth protocol stack upper-layer module parses the preset identification of the Bluetooth data packet from the preset field;
the Bluetooth protocol stack upper-layer module sets the preset field of the Bluetooth data packet as the preset identification, and the multi-Bluetooth driver module parses the preset identification of the Bluetooth data packet from the preset field.

12. The smart device according to claim 11, wherein the Bluetooth protocol stack upper-layer module restores the preset field to preset data after parsing the preset identification of the Bluetooth data packet from the preset field;
the multi-Bluetooth driver module restores the preset field to preset data after parsing the preset identification of the Bluetooth data packet from the preset field.

13. The smart device according to claim 11, wherein the Bluetooth protocol stack upper-layer module and the multi-Bluetooth driver module identify the data type to which the Bluetooth data packet belongs before parsing the Bluetooth data packet, and determine the position of the preset field based on the data type, where the data type and the preset field correspond one-to-one.

14. The smart device according to claim 13, wherein the preset field is the 8th and 9th bytes of the header of the Bluetooth data packet; or
the preset field is the 14th and 15th bytes of the header of the Bluetooth data packet.

15. The smart device according to claim 11, wherein the preset field is located in the header of the Bluetooth data packet.

16. The smart device according to claim 9, wherein the Bluetooth protocol stack upper-layer module and the multi-Bluetooth driver module store the correspondence relationship between the preset identifications and the Bluetooth chips.

17. The smart device according to claim 9, wherein the multi-Bluetooth driver module comprises at least two serial interfaces, each of which is connected to one of the Bluetooth chips.

18. The smart device according to claim 10, wherein the multi-Bluetooth driver module sets a preset field of the Bluetooth data packet as the preset identification, and the Bluetooth protocol stack upper-layer module parses the preset identification of the Bluetooth data packet from the preset field;
the Bluetooth protocol stack upper-layer module sets the preset field of the Bluetooth data packet as the preset identification, and the multi-Bluetooth driver module parses the preset identification of the Bluetooth data packet from the preset field.

19. The smart device according to claim 18, wherein the Bluetooth protocol stack upper-layer module restores the preset field to preset data after parsing the preset identification of the Bluetooth data packet from the preset field;
the multi-Bluetooth driver module restores the preset field to preset data after parsing the preset identification of the Bluetooth data packet from the preset field.

20. The smart device according to claim 18, wherein the Bluetooth protocol stack upper-layer module and the multi-Bluetooth driver module identify the data type to which the Bluetooth data packet belongs before parsing the Bluetooth data packet, and determine the position of the preset field based on the data type, where the data type and the preset field correspond one-to-one.
